(19) United States
(12) Patent Application Publication
(10) Pub. No.: US 2026/0106533 A1
(43) Pub. Date: Apr. 16, 2026

(54) VOLTAGE CONVERSION SYSTEM, CIVIL ENGINEERING MACHINE SYSTEM, CONTROL METHOD, AND NON-TRANSITORY COMPUTER STORAGE MEDIUM

(71) Applicant: KOMATSU LTD., Tokyo (JP)

(72) Inventors: Takuya SATO, Tokyo (JP); Go SAKUMA, Tokyo (JP)

(73) Assignee: KOMATSU LTD., Tokyo (JP)

(21) Appl. No.: 19/105,039

(22) PCT Filed: Oct. 18, 2023
(86) PCT No.: PCT/JP2023/037707

§ 371 Date: Feb. 20, 2025

(30) Foreign Application Priority Data
Oct. 20, 2022 (JP) 2022-168361

(51) Int. Cl. H02M 1/00; H02M 3/335

(52) U.S. Cl. CPC H02M 1/0077; H02M 3/33573; H02M 3/33576

(57) ABSTRACT

A voltage conversion system includes: a plurality of DC-DC converters having inputs connected in parallel and having outputs connected in series; and a switch provided in parallel to the output of at least one DC-DC converter of the plurality of DC-DC converters and turning into an on-state or an off-state, based on a rotation command of a motor.

### TECHNICAL FIELD

The present disclosure relates to a voltage conversion system, a civil engineering machine system, a control method, and a program.

The present application claims the priority of Japanese Patent Application No. 2022-168361 filed in Japan on Oct. 20, 2022, the contents of which are incorporated herein by reference.

### BACKGROUND ART

In recent years, in order to use clean energy instead of fossil fuels as the power of a civil engineering machine, installing a motor in the civil engineering machine and driving the motor by electricity have been considered. PTL 1 describes a technique relating to a power supply system using a plurality of power generation devices.

### CITATION LIST

### Patent Literature

Patent Literature 1: JP2017-216847A

### SUMMARY OF INVENTION

### Technical Problem

Incidentally, efficient traveling is desired in the traveling of a civil engineering machine.

The present disclosure has been made in view of the above circumstances, and an object of the present disclosure is to provide a voltage conversion system, a civil engineering machine system, a control method, and a program for realizing efficient traveling in the traveling of a civil engineering machine.

### Solution to Problem

According to an aspect of the present disclosure, a voltage conversion system includes: a plurality of DC-DC converters having inputs connected in parallel and having outputs connected in series; and a switch provided in parallel to the output of at least one DC-DC converter of the plurality of DC-DC converters and turning into an on-state or an off-state, based on a rotation command of a motor.

### Advantageous Effects of Invention

The voltage conversion system, the civil engineering machine system, the control method, and the program according to the present disclosure can realize efficient traveling in the traveling of a civil engineering machine.

### BRIEF DESCRIPTION OF DRAWINGS

FIG. 1 is a diagram illustrating an example of the configuration of a civil engineering machine system according to an embodiment of the present disclosure.

FIG. 2 is a diagram illustrating an example of the configuration of a drive device according to the embodiment of the present disclosure.

FIG. 3 is a diagram illustrating an example of the relationship between a rotation command value and a voltage value supplied to an inverter in the embodiment of the present disclosure.

FIG. 4 is a diagram illustrating an example of the relationship between the rotation command value and a switch command in the embodiment of the present disclosure.

FIG. 5 is a diagram illustrating an example of the configuration of a voltage conversion system according to the embodiment of the present disclosure.

FIG. 6 is a diagram illustrating a first example of the configuration of a DC-DC converter according to the embodiment of the present disclosure.

FIG. 7 is a diagram illustrating a second example of the configuration of the DC-DC converter according to the embodiment of the present disclosure.

FIG. 8 is a diagram illustrating an example of the processing flow of the civil engineering machine system according to the embodiment of the present disclosure.

FIG. 9 is a diagram illustrating an example of a relationship between a rotation command value and a voltage value supplied to an inverter in another embodiment of the present disclosure.

FIG. 10 is a schematic block diagram illustrating the configuration of a computer according to at least one embodiment.

### DESCRIPTION OF EMBODIMENTS

Hereinafter, embodiments of the present disclosure will be described with reference to the drawings. In the drawings, the same or corresponding components are denoted by the same reference signs, and the description thereof is omitted as appropriate.

### Embodiment

### Configuration of Civil Engineering Machine System

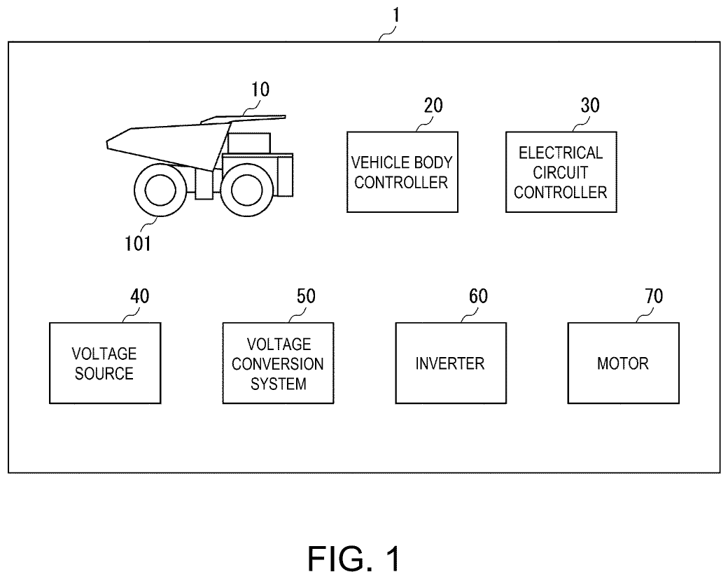

FIG. 1 is a diagram illustrating an example of the configuration of a civil engineering machine system 1 according to an embodiment of the present disclosure. As shown in FIG. 1, the civil engineering machine system 1 includes a vehicle body 10, a vehicle body controller 20, an electrical circuit controller 30, a voltage source 40, a voltage conversion system 50, an inverter 60, and a motor 70. An example of the civil engineering machine system 1 may be a dump truck or the like.

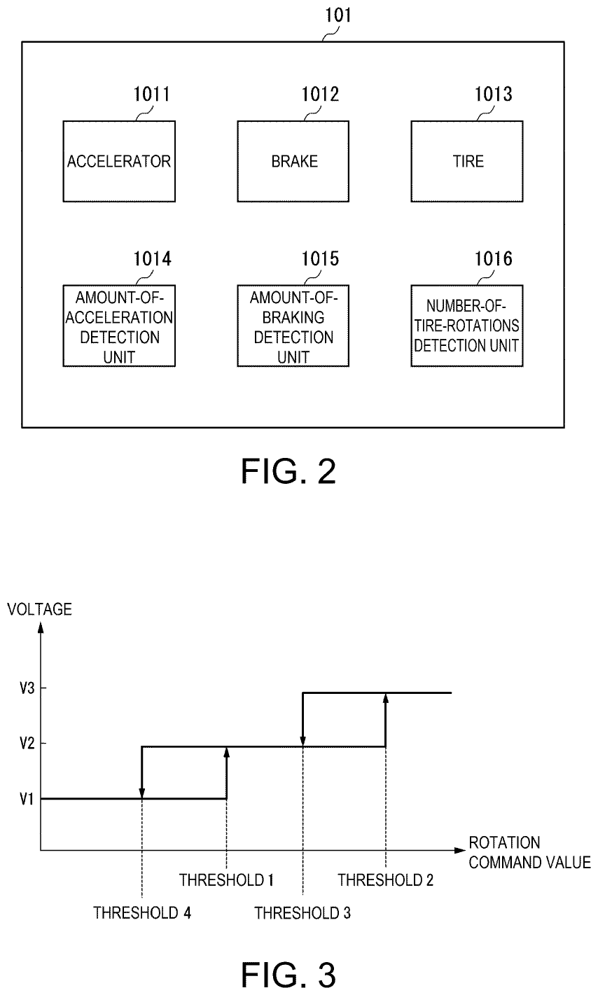

The vehicle body 10 includes a drive device 101. FIG. 2 is a diagram illustrating an example of the configuration of the drive device 101 according to the embodiment of the present disclosure. As illustrated in FIG. 2, the drive device 101 includes an accelerator 1011, a brake 1012, a tire 1013, an amount-of-acceleration detection unit 1014, an amount-of-braking detection unit 1015, and a number-of-tire-rotations detection unit 1016.

The accelerator 1011 accelerates the vehicle body 10. The brake 1012 decelerates the vehicle body 10. The tire 1013 rotates in accordance with acceleration and deceleration of the vehicle body 10 by the accelerator 1011 and the brake 1012 and thus causes the vehicle body 10 to travel.

The amount-of-acceleration detection unit 1014 detects the amount of acceleration caused by the accelerator 1011. The amount-of-acceleration detection unit 1014 outputs the detected amount of acceleration to the vehicle body controller 20.

The amount-of-braking detection unit 1015 detects the amount of deceleration caused by the brake 1012. The amount-of-braking detection unit 1015 outputs the detected amount of deceleration to the vehicle body controller 20.

The number-of-tire-rotations detection unit 1016 detects the number of rotations of the tire 1013. The number-of-tire-rotations detection unit 1016 outputs the detected number of rotations to the vehicle body controller 20.

The vehicle body controller 20 receives the amount of acceleration, the amount of deceleration, and the number of tire rotations from the drive device 101. The vehicle body controller 20 generates a torque command and a rotation command, based on the amount of acceleration, the amount of deceleration, and the number of tire rotations that are received. The vehicle body controller 20 outputs the generated torque command and rotation command to the electrical circuit controller 30.

The electrical circuit controller 30 receives the torque command and the rotation command from the vehicle body controller 20. Then, the electrical circuit controller 30 outputs the torque command and the rotation command to the inverter 60. Also, the electrical circuit controller 30 calculates a voltage command value necessary for driving the motor 70 corresponding to the torque command and the rotation command that are received, and thus generates a voltage command. Then, the electrical circuit controller 30 outputs the voltage command to a DC-DC converter 501. Also, the electrical circuit controller 30 calculates a switching between an on-state and an off-state of a switch 502, described later, such that the inverter 60 can follow the command values, and thus generates a switch command. Then, the electrical circuit controller 30 outputs the switch command to the switch 502.

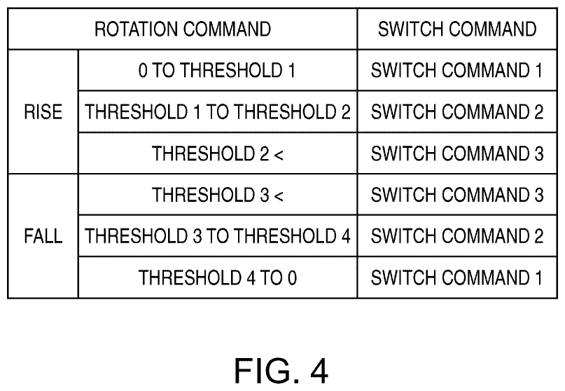

Here, the switch command will be described. In a region where the number of rotations of the motor 70 is low, when the voltage supplied to the inverter 60 is low, heat generation occurring in the inverter 60 can be suppressed and efficiency can be increased. Therefore, the electrical circuit controller 30 changes the switch command according to the value indicated by the rotation command and changes the magnitude of the DC voltage output from the voltage conversion system 50 (that is, the DC voltage input to the inverter 60), and thus increases the efficiency of the inverter 60. FIG. 3 is a diagram illustrating an example of the relationship between the rotation command value and the voltage value supplied to the inverter 60 in the embodiment of the present disclosure. FIG. 4 is a diagram illustrating an example of the relationship between the rotation command value and the switch command in the embodiment of the present disclosure. For example, when the switch command is a switch command 1, each switch 502 turns into a state corresponding to the switch command 1 and thus the voltage conversion system 50 outputs a DC voltage V1. Also, when the switch command is a switch command 2, each switch 502 turns into a state corresponding to the switch command 2 and thus the voltage conversion system 50 outputs a DC voltage V2. Also, when the switch command is a switch command 3, each switch 502 turns into a state corresponding to the switch command 3 and thus the voltage conversion system 50 outputs a DC voltage V3. For example, as shown in FIG. 4, in the case where the rotation command value rises, the electrical circuit controller 30 generates the switch command 1 when the rotation command value is in a range from 0 to a threshold 1, generates the switch command 2 when the rotation command value is in a range from the threshold 1 to a threshold 2, and generates the switch command 3 when the rotation command value exceeds the threshold 2, in accordance with the received rotation command. Also, for example, as shown in FIG. 4, in the case where the rotation command value falls, the electrical circuit controller 30 generates the switch command 3 when the rotation command value exceeds a threshold 3, generates the switch command 2 when the rotation command value is in a range from the threshold 3 to a threshold 4, and generates the switch command 1 when the rotation command value is lower than the threshold 4, in accordance with the received rotation command.

The voltage source 40 supplies a DC voltage to each of a plurality of DC-DC converters 501 provided in the voltage conversion system 50.

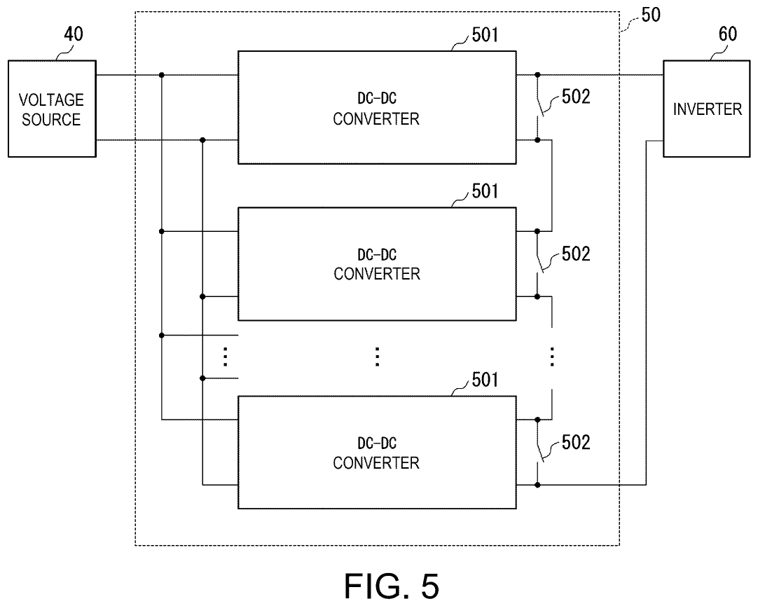

FIG. 5 is a diagram illustrating an example of the configuration of the voltage conversion system 50 according to the embodiment of the present disclosure. As illustrated in FIG. 5, the voltage conversion system 50 includes a plurality of DC-DC converters 501 and a plurality of switches 502.

As shown in FIG. 5, each of the plurality of DC-DC converters 501 is connected in such a way that the inputs thereof are in parallel. Also, as shown in FIG. 5, each of the plurality of DC-DC converters 501 is connected in such a way that the outputs thereof are in series. Each of the plurality of DC-DC converters 501 can convert the DC voltage supplied from the voltage source 40 into a preset DC voltage. Each of the DC-DC converters 501 in the preset state is a DC-DC converter designed to have a high voltage conversion efficiency. The number of DC-DC converters 501 is determined according to the DC voltage supplied to the inverter 60.

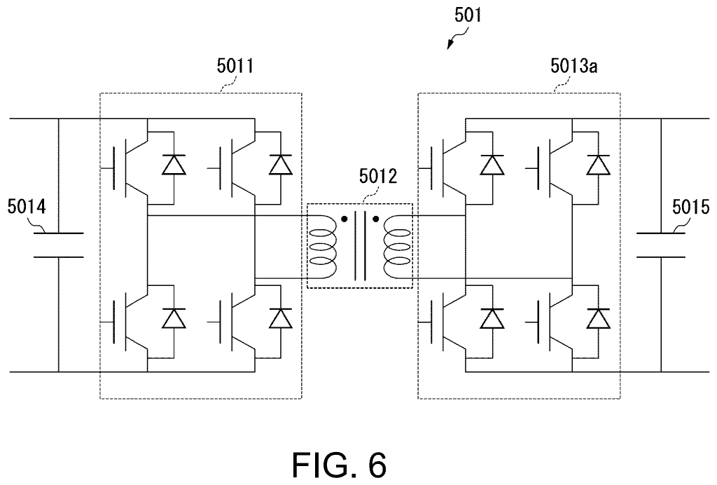

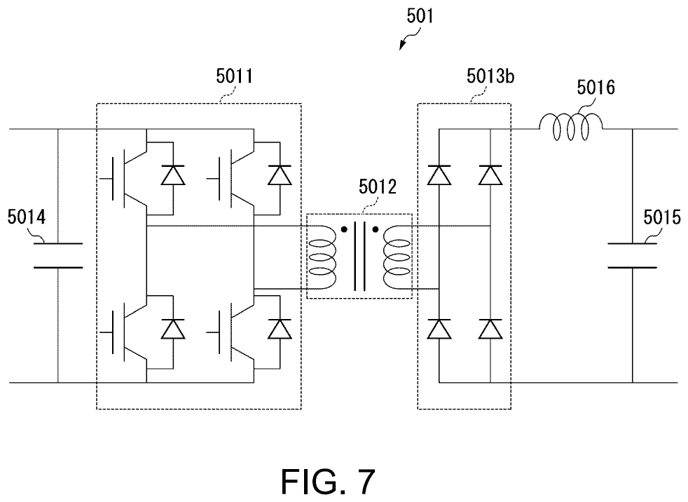

FIG. 6 is a diagram illustrating a first example of the configuration of the DC-DC converter 501 according to the embodiment of the present disclosure. FIG. 7 is a diagram illustrating a second example of the configuration of the DC-DC converter 501 according to the embodiment of the present disclosure. Each of the DC-DC converters 501 is, for example, an isolated converter as shown in FIGS. 6 and 7. The DC-DC converter 501 illustrated in FIG. 6 includes an inverter 5011, a transformer 5012, a rectifier circuit 5013a, and capacitors 5014 and 5015. The DC-DC converter 501 illustrated in FIG. 7 includes an inverter 5011, a transformer 5012, a rectifier circuit 5013b, capacitors 5014 and 5015, and an inductor 5016.

The inverter 5011 generates a desired voltage, for example, by a switching of a semiconductor element such as an insulated-gate bipolar transistor (IGBT) or a metal-oxide-semiconductor field-effect transistor (MOSFET). The voltage generated by the inverter 5011 is applied to the primary coil of the transformer 5012.

The transformer 5012 converts the voltage applied to the primary coil to a voltage corresponding to the turn ratio between the primary coil and the secondary coil, and outputs the voltage from the secondary coil. The voltage output from the secondary coil is applied to the input of the rectifier circuit 5013 (5013a or 5013b).

The rectifier circuit 5013a is configured with a semiconductor element such as an IGBT or a MOSFET. The rectifier circuit 5013b is configured with a diode. The rectifier circuit 5013 rectifies the AC voltage output from the secondary coil of the transformer 5012 to generate a DC voltage.

The capacitor 5014 stabilizes the DC voltage applied to the input of the inverter 5011 to a constant voltage. The capacitor 5015 stabilizes the DC voltage output by the rectifier circuit 5013 to a constant voltage. The inductor 5016, together with the capacitor 5015, forms a filter and removes a voltage of an unnecessary frequency component.

Each DC-DC converter 501 is not limited to the DC-DC converter shown in FIGS. 6 and 7 and may be any DC-DC converter, provided that a desired DC voltage can be generated.

The number of the plurality of switches 502 is the same as that of the plurality of DC-DC converters 501. Examples of the switch 502 include a semiconductor element such as an insulated-gate bipolar transistor (IGBT) and a metal-oxide-semiconductor field-effect transistor (MOSFET), and a physical switch or the like. As shown in FIG. 5, one switch 502 is connected in parallel to the output of one DC-DC converter 501. Each switch 502 turns into the on-state or the off-state in response to a switch command. The output of the DC-DC converter 501 where the switch 502 is in the on-state is short-circuited. Therefore, the output voltage of the DC-DC converter 501 is 0 volts. The output of the DC-DC converter 501 where the switch 502 is in the off-state is opened. Therefore, the output voltage of the DC-DC converter 501 is a preset DC voltage. Thus, the voltage conversion system 50 can generate a desired DC voltage. The voltage conversion system 50 supplies the generated DC voltage to the inverter 60. Note that the voltage conversion system 50 generates a relatively low voltage when the vehicle body 10 starts traveling or is traveling at a low speed, and that the voltage conversion system 50 generates a relatively high voltage when the vehicle body 10 is traveling at a high speed. This is based on the idea that, in the region where the number of rotations of the motor 70 is low, when the voltage supplied to the inverter 60 is low, heat generation occurring in the inverter 60 can be suppressed and efficiency can be increased.

The inverter 60 generates an AC voltage to drive the motor 70 from the DC voltage supplied from the voltage conversion system 50. The inverter 60 outputs the generated AC voltage to the motor 70.

The motor 70 rotates according to the AC voltage output from the inverter 60. As the tire 1013 rotates according to the rotation of the motor 70, the vehicle body 10 travels.

### Processing Performed by Civil Engineering Machine System

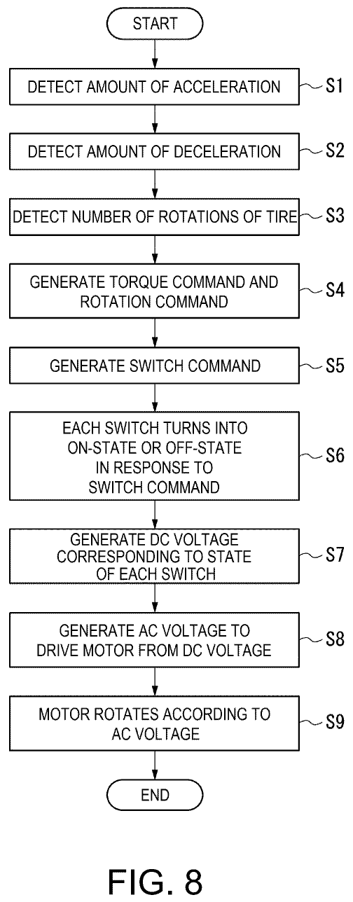

FIG. 8 is a diagram illustrating an example of the processing flow of the civil engineering machine system 1 according to the embodiment of the present disclosure. Next, the processing performed by the civil engineering machine system 1 will be described with reference to FIG. 8.

The operator of the civil engineering machine system 1 performs an operation of causing the vehicle body 10 to travel, on at least one of the accelerator 1011 and the brake 1012. The amount-of-acceleration detection unit 1014 detects the amount of acceleration in accordance with the operation on the accelerator 1011 (step S1). Then, the amount-of-acceleration detection unit 1014 outputs the detected amount of acceleration to the vehicle body controller 20. Meanwhile, the amount-of-braking detection unit 1015 detects the amount of deceleration corresponding to the operation on the brake 1012 (step S2). Then, the amount-of-braking detection unit 1015 outputs the detected amount of deceleration to the vehicle body controller 20. The number-of-tire-rotations detection unit 1016 detects the number of rotations of the tire 1013 (step S3). Then, the number-of-tire-rotations detection unit 1016 outputs the detected number of rotations to the vehicle body controller 20.

The vehicle body controller 20 receives the amount of acceleration, the amount of deceleration, and the number of tire rotations from the drive device 101. The vehicle body controller 20 generates a torque command and a rotation command, based on the amount of acceleration, the amount of deceleration, and the number of tire rotations that are received (step S4). The vehicle body controller 20 outputs the generated torque command and rotation command to the electrical circuit controller 30.

The electrical circuit controller 30 receives the torque command and the rotation command from the vehicle body controller 20. Then, the electrical circuit controller 30 outputs the torque command and the rotation command to the inverter 60. Also, the electrical circuit controller 30 calculates a voltage command value necessary for driving the motor 70 corresponding to the torque command and the rotation command that are received, and thus generates a voltage command. Then, the electrical circuit controller 30 outputs the voltage command to a DC-DC converter 501. Also, the electrical circuit controller 30 calculates the switching between the on-state and the off-state of a switch 502, described later, such that the inverter 60 can follow the command values, and thus generates a switch command (step S5). Then, the electrical circuit controller 30 outputs the switch command to the switch 502. Each switch 502 turns into the on-state or the off-state in response to the switch command (step S6). The voltage conversion system 50 generates a DC voltage corresponding to the state of each switch 502 (that is, a desired DC voltage) (step S7). The voltage conversion system 50 supplies the generated DC voltage to the inverter 60.

The inverter 60 generates an AC voltage to drive the motor 70 from the DC voltage supplied from the voltage conversion system 50 (step S8). The inverter 60 outputs the generated AC voltage to the motor 70.

The motor 70 rotates according to the AC voltage output from the inverter 60 (step S9). As the tire 1013 rotates according to the rotation of the motor 70, the vehicle body 10 travels.

### Effects

The civil engineering machine system 1 according to the embodiment of the present disclosure has been described above. In the civil engineering machine system 1 according to the embodiment of the present disclosure, the voltage conversion system 50 includes the plurality of DC-DC converters 501 having inputs connected in parallel and having outputs connected in series, and the switch 502 provided in parallel to the outputs of the plurality of DC-DC converters 501 and turning into the on-state or the off-state, based on the rotation command of the motor 70. Such a voltage conversion system 50 can realize efficient traveling in the traveling of the civil engineering machine (vehicle body).

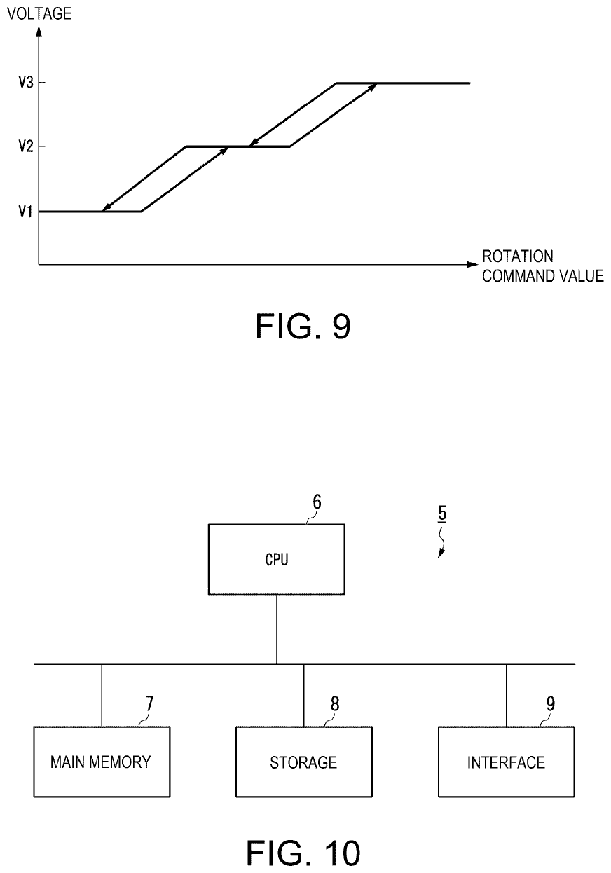

Also, in another embodiment of the present disclosure, the relationship between the rotation command value and the voltage value supplied to the inverter 60 is not limited to the relationship illustrated in FIG. 3. For example, FIG. 9 is a diagram illustrating an example of the relationship between the rotation command value and the voltage value supplied to the inverter 60 in another embodiment of the present disclosure. In another embodiment of the present disclosure, the relationship between the rotation command value and the voltage value supplied to the inverter 60 may not be a relationship having a hysteresis in which the voltage value changes suddenly at the threshold of the rotation command value, but may be a relationship having a hysteresis in which the voltage value gradually changes according to the rotation command value as illustrated in FIG. 9. In this case, the relationship between the rotation command value and the switch command is not the relationship illustrated in FIG. 4, but is a relationship between the rotation command value and the switch command such that the voltage value gradually changes according to the rotation command value.

Also, in another embodiment of the present disclosure, a part of the drive device 101 (for example, the accelerator 1011 and the brake 1012) or the entirety thereof may be present outside the vehicle body 10, and the vehicle body 10 may be remotely controlled to travel.

Note that the switch 502 may not be provided at the outputs of all the DC-DC converters 501. That is, the switch 502 may be provided at the output of at least one DC-DC converter among all of the DC-DC converters 501. For example, in another embodiment of the present disclosure, the switch 502 may be provided at the output of the DC-DC converter 501 to the minimum necessary extent or more, provided that the voltage conversion system 50 can realize a desired DC voltage. In the embodiment of the present disclosure, an example where the switch 502 is switched in relation to the three DC-DC converters 501, thus to realize three patterns of voltages, that is, the output voltage of one DC-DC converter 501, the output voltages of the two DC-DC converters 501, and the output voltages of the three DC-DC converters 501, is described. However, in another embodiment of the present disclosure, the switch 502 may be switched in relation to n DC-DC converters 501 or more, n being 4, or the output voltage of an integral number of DC-DC converters 501, the integral number being one of 1 to n, may be realized by switching the switch 502. Note that, when the output voltage of which integral number of DC-DC converters 501, of 1 to n, is to be output is determined, the switch 502 necessary for realizing the output voltage may be provided.

Also, in another embodiment of the present disclosure, the set value and the set number of the threshold value of the rotation command value may be changed from those described above. In this case, the set value and the set number of the voltage value supplied to the inverter 60 according to the rotation command value may be changed from those described above.

Also, with respect to the processing in the embodiment of the present disclosure, the order of the processing may be changed within a range such that appropriate processing is performed.

Each of the storage unit and the storage device (including a register and a latch) in the embodiment of the present disclosure may be provided anywhere in a range such that appropriate information is transmitted and received. Also, as each of the storage unit and the storage device, a plurality of storage units and storage devices may be present and may store data in a distributed manner within a range such that appropriate information is transmitted and received.

While the embodiment of the present disclosure has been described, the above-described civil engineering machine system 1, the drive device 101, the vehicle body controller 20, the electrical circuit controller 30, and the other control devices may have a computer system inside. The above-described procedures of the processing are stored in the form of a program in a computer-readable recording medium, and the computer reads out and executes this program and thus performs the above processing. A specific example of the computer is given below.

FIG. 10 is a schematic block diagram illustrating the configuration of a computer according to at least one embodiment. As shown in FIG. 10, a computer 5 includes a CPU 6, a main memory 7, a storage 8, and an interface 9. For example, each of the civil engineering machine system 1, the drive device 101, the vehicle body controller 20, the electrical circuit controller 30, and the other control devices described above is implemented on the computer 5. Also, the operation of each of the above-described processing units is stored in the form of a program in the storage 8. The CPU 6 reads out the program from the storage 8, loads the program into the main memory 7, and executes the above processing in accordance with the program. The CPU 6 secures a storage area corresponding to each of the above-described storage units, in the main memory 7 in accordance with the program.

Examples of the storage 8 include a hard disk drive (HDD), a solid-state drive (SSD), a magnetic disk, a magneto-optical disc, a compact disc read-only memory (CD-ROM), a digital versatile disc read-only memory (DVD-ROM), and a semiconductor memory or the like. The storage 8 may be an internal medium directly connected to the bus of the computer 5 or may be an external medium connected to the computer 5 via the interface 9 or a communication line. Also, when the program is distributed to the computer 5 via a communication line, the computer 5 receiving the distribution may load the program into the main memory 7 and execute the above processing. In at least one embodiment, the storage 8 is a non-transitory tangible storage medium.

The above program may realize some of the functions described above. Moreover, the above program may be a file that can realize the above-described functions in combination with a program already recorded in the computer system, a so-called differential file (difference program).

While some embodiments of the present disclosure have been described, these embodiments have been presented by way of example only, and are not intended to limit the scope of the disclosure. Various additions, various omissions, various substitutions, and various changes may be made to these embodiments without departing from the gist of the disclosure.

While the embodiments of the present disclosure have been described above, the present disclosure is not limited thereto, and additions, omissions, substitutions, and other changes of the configurations can be made without departing from the spirit of the present disclosure, and the above-described embodiments can be combined as appropriate.

### Appendix 1

A voltage conversion system including:
a plurality of DC-DC converters having inputs connected in parallel and having outputs connected in series; and
a switch provided in parallel to the output of at least one DC-DC converter of the plurality of DC-DC converters and turning into an on-state or an off-state, based on a rotation command of a motor.

### Appendix 2

The voltage conversion system according to Appendix 1, wherein
the switch
turns into the on-state or the off-state in response to a switch command determined based on a relationship between a value of the rotation command and a voltage supplied to an inverter.

### Appendix 3

The voltage conversion system according to Appendix 2, wherein
the relationship between the value of the rotation command and the voltage supplied to the inverter
has a hysteresis relationship.

### Appendix 4

The voltage conversion system according to any one of Appendices 1 to 3, wherein
the switch
turns into the on-state or the off-state in response to a switch command determined based on a threshold value of a value of the rotation command.

### Appendix 5

A civil engineering machine system including:
the voltage conversion system according to any one of Appendices 1 to 4; and
a controller configured to control the on-state and the off-state of the switch.

### Appendix 6

A control method including:
controlling a switch provided in parallel to an output of at least one DC-DC converter of a plurality of DC-DC converters having inputs connected in parallel and having outputs connected in series, into an on-state or an off-state, based on a rotation command of a motor.

### Appendix 7

A program causing
a computer to execute
controlling a switch provided in parallel to an output of at least one DC-DC converter of a plurality of DC-DC converters having inputs connected in parallel and having outputs connected in series, into an on-state or an off-state, based on a rotation command of a motor.

### INDUSTRIAL APPLICABILITY

The voltage conversion system, the civil engineering machine system, the control method, and the program according to the present disclosure can realize efficient traveling in the traveling of a civil engineering machine.

### REFERENCE SIGNS LIST

1 civil engineering machine system
5 computer
6 CPU
7 main memory
8 storage
9 interface
10 vehicle body
20 vehicle body controller
30 electrical circuit controller
40 voltage source
50 voltage conversion system
60 inverter
70 motor
101 drive device
501 DC-DC converter
502 switch
1011 accelerator
1012 brake
1013 tire
1014 amount-of-acceleration detection unit
1015 amount-of-braking detection unit
1016 number-of-tire-rotations detection unit
5011 inverter
5012 transformer
5013 rectifier circuit
5014, 5015 capacitor
5016 inductor

1. A voltage conversion system comprising:
a plurality of DC-DC converters having inputs connected in parallel and having outputs connected in series; and
a switch provided in parallel to the output of at least one DC-DC converter of the plurality of DC-DC converters, and turning into an on-state or an off-state, based on a rotation command of a motor.

2. The voltage conversion system according to claim 1, wherein
the switch turns into the on-state or the off-state in response to a switch command determined based on a relationship between a value of the rotation command and a voltage supplied to an inverter.

3. The voltage conversion system according to claim 2, wherein
the relationship between the value of the rotation command and the voltage supplied to the inverter has a hysteresis relationship.

4. The voltage conversion system according to claim 1, wherein
the switch turns into the on-state or the off-state in response to a switch command determined based on a threshold value of a value of the rotation command.

5. A civil engineering machine system comprising:
the voltage conversion system according to claim 1; and
a controller configured to control the on-state and the off-state of the switch.

6. A control method comprising:
controlling, a switch provided in parallel to an output of at least one DC-DC converter of a plurality of DC-DC converters having inputs connected in parallel and having outputs connected in series, into an on-state or an off-state, based on a rotation command of a motor.

7. A non-transitory computer storage medium storing a program causing a computer to execute:
controlling, a switch provided in parallel to an output of at least one DC-DC converter of a plurality of DC-DC converters having inputs connected in parallel and having outputs connected in series, into an on-state or an off-state, based on a rotation command of a motor.

8. The voltage conversion system according to claim 2, wherein
the switch turns into the on-state or the off-state in response to a switch command determined based on a threshold value of a value of the rotation command.

9. The voltage conversion system according to claim 3, wherein
the switch turns into the on-state or the off-state in response to a switch command determined based on a threshold value of a value of the rotation command.
